(19) United States
(12) Patent Application Publication
(10) Pub. No.: US 2020/0283640 A1
(43) Pub. Date: Sep. 10, 2020

(54) COATED PRODUCT, POWDER COATING MATERIAL SET, AND METHOD FOR MANUFACTURING COATED PRODUCT

(71) Applicant: FUJI XEROX CO., LTD., Tokyo (JP)

(72) Inventors: Susumu YOSHINO, Kanagawa (JP); Kiyohiro YAMANAKA, Kanagawa (JP); Hiroshi SAEGUSA, Kanagawa (JP); Yoichiro EMURA, Kanagawa (JP); Hirofumi SHIOZAKI, Kanagawa (JP); Satoshi YOSHIDA, Kanagawa (JP)

(73) Assignee: FUJI XEROX CO., LTD., Tokyo (JP)

(21) Appl. No.: 16/521,543

(22) Filed: Jul. 24, 2019

(30) Foreign Application Priority Data
Mar. 8, 2019 (JP) 2019-042736

(51) Int. Cl. C09D 5/03; C09D 5/00; C09D 133/14; C09D 175/06

(52) U.S. Cl. CPC C09D 5/031; C09D 175/06; C09D 133/14; C09D 5/002

(57) ABSTRACT

A coated product includes two or more coated layers, in which a degree of interface roughness Ra between a first layer in the coated film layer and a second layer in contact with the first layer is 1 μm to 10 μm.

### CROSS-REFERENCE TO RELATED APPLICATIONS

This application is based on and claims priority under 35 USC 119 from Japanese Patent Application No. 2019-042736 filed Mar. 8, 2019.

### BACKGROUND

### (i) Technical Field

The present invention relates to a coated product, a powder coating material set, and a method for manufacturing a coated product.

### (ii) Related Art

Recently, in a powder coating technology using a powder coating material, the discharge amount of a volatile organic compound (VOC) is reduced in a coating step, and the powder coating material which has not been attached to an object to be coated is collected after coating and is able to be reused, and thus, the powder coating technology has attracted attention from the viewpoint of the global environment. For this reason, various powder coating materials have been studied.

As coated metal plates of the related art, the coated metal plate disclosed in JP2006-175810A is known.

JP2006-175810A discloses the coated metal plate that is formed of a coated film which has an undercoat layer formed on a metal plate and an overcoat layer thereon, and in which the undercoat layer is made of polyester as main resin, and the overcoat layer is made of high molecular weight polyester with a molecular weight of 5000 or more as main resin. In the coated metal plate, a degree of roughness Ra of the interface between the undercoat layer and the overcoat layer is 0.3 to 0.7 μm, a glass transition temperature (Tg) of the undercoat layer is 5 to 25° C., and a glass transition temperature of the overcoat layer is 35° C. to 60° C.

In addition, as powder coating materials of the related art, powder coating materials disclosed in JP1998-231446A (Alias: JP H10-231446A) or JP1996-209033A (Alias: JP H08-209033A) are known.

JP1998-231446A (Alias: JP H10-231446A) discloses a powder coating material that is formed of a powder which has a volume average particle diameter of 3 to 30 μm and has a film-forming resin as a main component, in which the powder includes a powder having a particle diameter of ⅕ or less of the above-mentioned volume average particle diameter at a ratio of 5% by weight or less.

JP1996-209033A (Alias: JP H08-209033A) discloses a powder coating material that is formed of a particle group which satisfies conditions in which an average particle diameter of a particle group is 20 μm or less, and 25% particle diameter under cumulative screen (D₂₅)/75% particle diameter under cumulative screen (D₇₅)) of a particle group is 0.6 or more.

### SUMMARY

Aspects of non-limiting embodiments of the present disclosure relate to a coated product that includes a first layer and a second layer as coated layers, which is a coated product excellent in adhesiveness between the first layer and the second layer in contact with the first layer, as compared to case in which a degree of interface roughness Ra between a first layer in the coated film layer and a second layer in contact with the first layer is less than 1 μm and more than 10 μm.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a coated product including two or more coated layers, in which a degree of interface roughness Ra between a first layer in the coated film layer and a second layer in contact with the first layer is 1 μm to 10 μm.

### BRIEF DESCRIPTION OF THE DRAWINGS

Exemplary embodiment(s) of the present invention will be described in detail based on the following figures, wherein:

FIG. 1 is a graph explaining a method of measuring a degree of interface roughness Ra of each coated film layer.

### DETAILED DESCRIPTION

The present exemplary embodiment will be described below. These descriptions and examples illustrate an exemplary embodiment and do not limit the scope of the exemplary embodiment.

In a numerical value range described stepwise in the present exemplary embodiment, an upper limit or a lower limit described in one numerical value range may be replaced with an upper limit or a lower limit of another numerical value range described stepwise. In addition, in a numerical value range described in the present exemplary embodiment, an upper limit value or a lower limit value of the numerical value range may be replaced with values shown in Example.

In the present exemplary embodiment, the term “step” is not limited to an independent step, and is included in the terms of the present exemplary embodiment as long as the intended purpose of the step is achieved even in a case where the step cannot be distinguished clearly from other steps.

In a case where the exemplary embodiment is described with reference to the drawings in the present exemplary embodiment, a configuration of the exemplary embodiment is not limited to a configuration shown in the drawings. Furthermore, sizes of members in the respective drawings are conceptual, and a relative relationship between the sizes of the members is not limited thereto.

In the present specification, “(meth)acrylate” represents both or any one of acrylate and methacrylate, “(meth)acrylic” represents both or any one of acrylic and methacryl, and “(meth)acryloyl” represents both or any one of acryloyl and methacryloyl.

In the present exemplary embodiment, each component may contain a plurality of corresponding substances. In a case of referring to an amount of each component in a composition in the present exemplary embodiment, this means a total amount of a plurality of types of substances present in the composition unless otherwise specified in a case where the plurality of types of substances corresponding to each component are present in the composition.

Coated Product

A coated product according to the present exemplary embodiment includes two or more coated layers, in which a degree of interface roughness Ra between a first layer in the coated film layer and a second layer in contact with the first layer is 1 μm to 10 μm.

In coated products of the related art, in many cases, performing functional separation type coating by coating two or more layers leads to simplification of the coating process, or energy saving and high productivity, but adhesiveness between two or more coated layers is not sufficient.

In a coated product having at least a first layer and a second layer as a coated film layer, by setting a degree of interface roughness Ra between the first layer and the second layer in contact with the first layer to 1 μm to 10 μm, the interface between the first layer and the second layer becomes a complicated shape, and a shape intruding into each other layer is generated. Therefore, adhesiveness between the layers is improved, and a coated product excellent in adhesiveness between the layers is obtained.

In addition, in the coated product according to the present exemplary embodiment, by setting a degree of interface roughness Ra between the first layer and the second layer in contact with the first layer to 1 μm to 10 μm, coating nonuniformity resulting from electrostatics of a coating material at the time of coating is suppressed, and therefore the coated product is also excellent for suppressing the color nonuniformity in the appearance of the coated product obtained.

Hereinafter, details of the coated product according to the present exemplary embodiment will be described.

The coated product according to the present exemplary embodiment includes two or more coated layers, and preferably includes two to five coated layers, and more preferably includes two or three coated layers, and particularly preferably includes two coated layers, although there is no particular limitation.

In addition, in the coated product according to the present exemplary embodiment, the second layer is, for example, preferably the outermost layer of the coated product from the viewpoint of suppression of color unevenness in the appearance.

In a case where the coated product according to the present exemplary embodiment includes three or more coated layers, a degree of interface roughness Ra is, for examples, preferably 1 μm to 10 μm between each of the coated layers other than the outermost layer from the viewpoint of adhesiveness between the coated layers.

A material of each of coating films is not particularly limited, and well known materials may be used, but a cured resin film is preferable, for example.

In addition, each of the coating films is, for example, preferably a coating film formed of a powder coating material, and the first layer and the second layer are, for example, preferably coating films formed of a powder coating material set according to the present exemplary embodiment to be described later.

Furthermore, each of the coating films may contain known additives. Examples thereof include colorants, particles, and the like. For example, each component in the powder coating material described in the powder coating material set according to the present exemplary embodiment to be described later is exemplified.

Each of the coated layers may be a colored layer or a transparent layer.

In addition, the first layer and the second layer may be layers of the same color or layers of different colors. Among them, in a case where the second layer is the outermost layer, although there is no particular limitation, a case in which the first layer is a colored layer and the second layer is a transparent layer, or the first layer is a colored layer and the second layer is a colored layer different from the first layer is preferable; a case in which the first layer is a colored layer and the second layer is a transparent layer, or the first layer is a white layer and the second layer is a colored layer different from the first layer is more preferable; and a case in which the first layer is a colored layer and the second layer is a transparent layer is particularly preferable.

A color of each of the coated layers is not particularly limited, and a desired color or a transparent layer may be used.

Among them, the second layer is, for example, preferably a colorless and transparent layer (a clear coated film layer, also simply referred to as a “clear layer”).

The term “colorless and transparent” in the present exemplary embodiment means that a transmittance of light with a wavelength of 400 nm to 750 nm is 80% or more.

In addition, the first layer is, for example, preferably a colored layer.

Degree of Interface Roughness Ra between First Layer and Second Layer In Contact With First Layer

The coated product according to the present exemplary embodiment includes two or more coated layers, in which a degree of interface roughness Ra between the first layer in the coated film layer and the second layer in contact with the first layer is 1 μm to 10 μm, and from the viewpoint of the adhesiveness between the first layer and the second layer and the suppression of color unevenness in the appearance, a degree of interface roughness Ra is preferably 1.1 μm to 9 μm, and is more preferably 1.2 μm to 8 μm, although there is no particular limitation.

A method of measuring a degree of interface roughness Ra between each of the coated film layer is as follows.

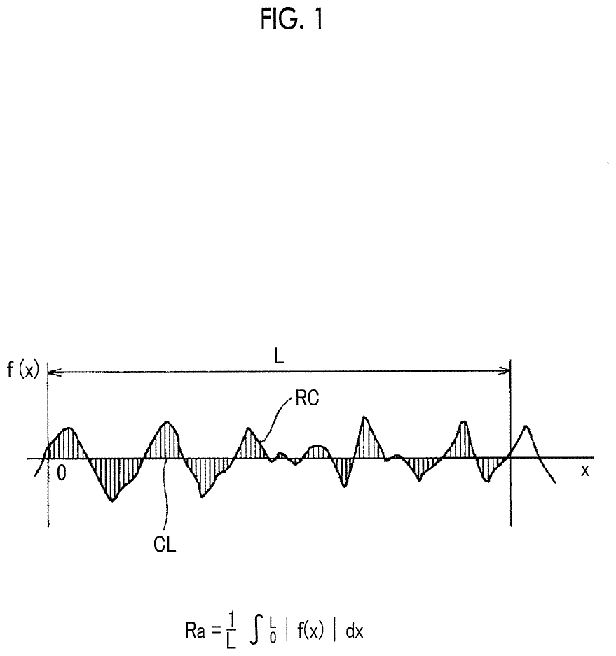

Cut pieces obtained by cutting the coated product are embedded in a resin and polished, the cross section perpendicular to the surface of the outermost layer in the coated layers is smoothed, and a 1,000×scanning electron micrograph is captured. Within a range of 500 μm or more in a direction parallel to the outermost surface of the coated film layer, a transparent sheet used for OHP is put on the photo, and after tracing the irregularities of the interface precisely, the area of the vertical lined portion as shown in FIG. 1 is measured by an image processing apparatus, and a degree of interface roughness Ra is obtained from the following equation as an average value.

Ra=(∫₀^{L}|f(x)|dx)/L

L represents a length in a direction parallel to the outermost surface of the measured coated film layer, and f(x) represents a distance from the center line CL at x of the roughness curve RC in the direction perpendicular to the surface of the outermost layer of the interface between the first layer and the second layer.

As a simpler method of measuring Ra, a method in which, after tracing the irregularities of the interface precisely, a line of an average value corresponding to the center line of FIG. 1 is drawn, a sheet is cut out along the traced curve, the weight of the upper and lower part of the line of the average value is measured, and the weight is converted to the average length to obtain Ra, may be used.

In addition, a method of measuring the average layer thickness of each coated film layer in the present exemplary embodiment is as follows. Within a range of a length of 500 μm or more in a direction parallel to the outermost surface of the coated film layer of a 1,000×scanning electron micrograph in the cross section, a thickness of each coated film layer is measured, and the average is obtained to calculate the average layer thickness.

Average Layer Thickness of First Layer

In the coated product according to the present exemplary embodiment, an average layer thickness of the first layer is, for example, preferably thicker than an average layer thickness of the second layer from the viewpoint of the adhesiveness between the first layer and the second layer and the suppression of color unevenness in the appearance.

In addition, although there is no particular limitation, an average layer thickness of the first layer is preferably 40 μm to 100 μm, is more preferably 45 μm to 90 μm, is even more preferably 50 μm to 85 μm, and is particularly preferably 60 μm to 80 μm from the viewpoint of the adhesiveness between the first layer and the second layer in the obtained coated product and the suppression of color unevenness in the appearance.

Average Layer Thickness of Second Layer

Although there is no particular limitation, an average layer thickness of the second layer is preferably less than 50 μm, is more preferably less than 40 μm, is even more preferably 5 μm or more and less than 40 μm, and is particularly preferably 10 μm or more and less than 40 μm from the viewpoint of the adhesiveness between the first layer and the second layer in the obtained coated product and the suppression of color unevenness in the appearance.

Ratio of Average Layer Thickness of First Layer to Average Layer Thickness of Second Layer

Although there is no particular limitation, a ratio (T1/T2) of an average layer thickness T1 of the first layer to an average layer thickness T2 of the second layer is preferably more than 1 and 7 or less, is more preferably 1.5 to 5, and is particularly preferably 1.8 to 4.5, from the viewpoint of the adhesiveness between the first layer and the second layer in the obtained coated product and the suppression of color unevenness in the appearance.

A total average layer thickness of the two or more coated layers is not particularly limited, but is, for example, preferably 40 μm to 500 μm, is more preferably 50 μm to 200 μm, and is particularly preferably 60 μm to 150 μm from the viewpoint of the suppression of color unevenness in the appearance.

Although there is no particular limitation, a total of the average layer thickness of the first layer and the second layer is preferably 40 μm to 200 μm, is more preferably 50 μm to 150 μm, and is particularly preferably 60 μm to 120 μm, from the viewpoint of the adhesiveness between the first layer and the second layer in the obtained coated product and the suppression of color unevenness in the appearance.

Surface Coverage of Coated Film Layer

Although there is no particular limitation, a surface coverage of the coated film layer in the coated product of the present exemplary embodiment is preferably 90% by area or more, is more preferably 95% by area or more, and is particularly preferably 96% by area to 100% by area from the viewpoint of the suppression of color unevenness in the appearance.

A surface coverage of the coated film layer in the coated product of the present exemplary embodiment is measured by an X-ray photoelectron spectrometer (XPS) at an area of at least 90,000 μm² on the surface of the coated product, and is calculated by a strength ratio between the material of the coated film layer and the material of the substrate which will be described later. In the XPS measurement, JPS-9000MX manufactured by JEOL Ltd. is used as a measurement device, and the measurement is performed using a MgKα ray as the X-ray source and setting an accelerating voltage to 10 kV and an emission current to 30 mA.

Surface Roughness Ra of Outermost Layer

A surface roughness Ra of the outermost surface of the coated film layer side of the coated product according to the present exemplary embodiment is, for example, preferably smaller than a degree of interface roughness Ra between the first layer and the second layer, from the viewpoint of the adhesiveness between the first layer and the second layer and the suppression of color unevenness in the appearance.

In addition, a surface roughness Ra of the outermost surface of the coated film layer side of the coated product according to the present exemplary embodiment is, for example, preferably less than 1 μm, is more preferably less than 0.5 μm, is even more preferably less than 0.2 μm, and is particularly preferably 0.01 μm to 0.2 μm, from the viewpoint of the adhesiveness between the first layer and the second layer and the suppression of color unevenness in the appearance.

A method of measuring a surface roughness Ra of the outermost surface of the coated film layer side of the coated product according to the present exemplary embodiment is performed according to JIS B0601 (1994) using a surface roughness measuring machine (SURFCOM 1400A, manufactured by Tokyo Seimitsu Co., Ltd.). The measurement is performed under conditions of a measurement length: 4 mm, a cutoff wavelength λc: 0.8 mm, and a measurement rate: 0.60 mm/s, and measured value is a value calculated as a center line average roughness Ra.

Substrate

Although there is no particular limitation, the coated product according to the present exemplary embodiment preferably further has a substrate, and more preferably has the two or more coating films on the substrate.

The coating film may be provided on the entire surface of the substrate or on at least a part of the surface of the substrate, and may be appropriately selected according to the desired coating site.

A material, a size, and a shape of the substrate is not particularly limited, and may be selected appropriately as necessary, and a well-known substrate is used.

Specific examples of substrates include various metal components, ceramic components, resin components, and the like. These substrate may be an unmolded product before being molded into each product such as a plate-shaped product and a linear product, or may be a molded product molded for electronic components, road vehicles, interior and exterior architectural materials, and the like. In addition, the substrate may be a product of which the surface to be coated is subjected to a surface treatment such as a primer treatment, a plating treatment, and electrodeposition coating.

A method for manufacturing a coated product according to the present exemplary embodiment is not particularly limited, but for example, a coated product is preferably manufactured by the method for manufacturing a coated product according to the present exemplary embodiment to be described later.

In addition, although there is no particular limitation, the coated product according to the present exemplary embodiment preferably has a first layer and a second layer formed by curing two layers at the same time, more preferably has a first layer and a second layer formed by curing two layers at the same time which are formed of two kinds of powder coating materials, and particularly preferably has a first layer and a second layer formed by curing two layers at the same time which are formed of two kinds of powder coating materials by one heat treatment.

Powder Coating Material Set

A powder coating material set includes a first powder coating material that contains a resin and a curing agent; and a second powder coating material that contains a resin and a curing agent, in which a ratio (D1/D2) of a volume average particle diameter D1 of the first powder coating material to a volume average particle diameter D2 of the second powder coating material is 1.6 to 7.

The above-mentioned powder coating material set is, for example, used for manufacture of the coated product according to the present exemplary embodiment.

Regarding the coated film layer formed by the above powder coating material set, a coated film layer formed by the first powder coating material is referred to as the first layer, and a coated film layer formed by the second powder coating material is referred to as a second layer. The first layer in the powder coating material set corresponds to the first layer in the coated product according to the present exemplary embodiment, and the second layer in the powder coating material set corresponds to the second layer in the coated product according to the present exemplary embodiment.

Ratio of Volume Average Particle Diameter D1 of First Powder Coating Material to Volume Average Particle Diameter D2 of Second Powder Coating Material

A ratio (D1/D2) of a volume average particle diameter D1 of the first powder coating material to a volume average particle diameter D2 of the second powder coating material is 1.6 to 7, and is, for example, preferably 1.8 to 7, and is more preferably 2.0 to 6.8 from the viewpoint of the adhesiveness between the first layer and the second layer in the obtained coated product and the suppression of color unevenness in the appearance.

A volume average particle diameter D₅₀ᵥ of the powder coating material and a volume average particle size distribution index GSDv are measured by LS Coulter (a particle size measuring device manufactured by Beckman Coulter, Inc.).

Cumulative distributions by volume are drawn from the side of the smallest diameter with respect to particle size ranges (channels) separated based on the measured particle diameter distribution. The particle diameter when the cumulative percentage becomes 16% is defined as that corresponding to a volume average particle diameter D₁₆ᵥ, while the particle diameter when the cumulative percentage becomes 50% is defined as that corresponding to a volume average particle diameter D₅₀ᵥ. Furthermore, the particle diameter when the cumulative percentage becomes 84% is defined as that corresponding to a volume average particle diameter D₈₄ᵥ.

A volume average particle size distribution index (GSDv) is calculated as (D₈₄ᵥ/D₁₆ᵥ)^{1/2}.

Volume Average Particle Diameter D1 of First Powder Coating Material

Although there is no particular limitation, a volume average particle diameter D1 of the first powder coating material is preferably 10 μm to 100 μm, is more preferably 30 μm to 90 μm, and is particularly preferably 40 μm to 80 μm from the viewpoint of the adhesiveness between the first layer and the second layer in the obtained coated product and the suppression of color unevenness in the appearance.

Volume Average Particle Diameter D2 of Second Powder Coating Material

Although there is no particular limitation, a volume average particle diameter D2 of the second powder coating material is preferably 5 μm to 25 μm, is more preferably 6 μm to 20 μm, and is particularly preferably 7 μm to 15 μm from the viewpoint of the adhesiveness between the first layer and the second layer in the obtained coated product and the suppression of color unevenness in the appearance.

Volume Average Particle Size Distribution Index GSDv of Powder Coating Material

Although there is no particular limitation, a volume average particle size distribution index GSDv of powder particles in the powder particles in the first powder coating material and the powder particles in the second powder coating material is preferably 1.50 or less, is more preferably 1.40 or less, and is particularly preferably 1.30 or less, from the viewpoint of smoothness of a coating film and storing properties of a powder coating material.

Ratio of Degree of Sphericity S1 of First Powder Coating Material to Sphericity S2 of Second Powder Coating Material

Although there is no particular limitation, a ratio (S1/S2) between a degree of sphericity S1 of the first powder coating material and a degree of sphericity S2 of the second powder coating material is preferably 0.90 or more and less than 1.00, is more preferably 0.92 to 0.98, and is particularly preferably 0.93 to 0.97 from the viewpoint of the adhesiveness between the first layer and the second layer in the obtained coated product and the suppression of color unevenness in the appearance.

A degree of sphericity of the powder coating material means an average circularity measured by the following method.

An average circularity of a powder coating material is measured by using a flow type particle image analyzer “FPIA-3000 (manufactured by Sysmex Corporation).” Specifically, 0.1 mL to 0.5 mL of a surfactant (alkyl benzene sulfonate) as a dispersant is added into 100 mL to 150 mL of water obtained by removing impurities which are solid matter in advance, and 0.1 g to 0.5 g of a measurement sample is further added thereto. A suspension in which the measurement sample is dispersed is subjected to a dispersion treatment with an ultrasonic dispersion device for 1 minute to 3 minutes, and a concentration of the dispersion liquid is 3,000 particles/μL to 10,000 particles/μL. With respect to this dispersion liquid, an average circularity of a powder coating material is measured by using the flow type particle image analyzer.

An average circularity of a powder coating material is a value obtained by obtaining a circularity (Ci) of each of n particles measured for the powder particles in the powder coating material, and then performing calculation by the following expression. In the following expression, Ci represents a circularity (=circumference length of circle equivalent to projection area of particle/circumference length of particle projection image), and fi represents frequency of the powder particles.

Average circularity (Ca)=(Σᵢ₌₁ⁿ(Ci×fi))/Σᵢ₌₁ⁿ(fi)

Degree of Sphericity S1 of First Powder Coating Material

Although there is no particular limitation, a degree of sphericity S1 of the first powder coating material is preferably 0.85 to 0.96, is more preferably 0.90 to 0.95, and is particularly preferably 0.92 to 0.94 from the viewpoint of the adhesiveness between the first layer and the second layer in the obtained coated product and the suppression of color unevenness in the appearance.

Degree of Sphericity S2 of Second Powder Coating Material

A degree of sphericity S2 of the second powder coating material is, for example, preferably a value larger than the degree of sphericity S1 of the first powder coating material from the viewpoint of the adhesiveness between the first layer and the second layer in the obtained coated product and the suppression of color unevenness in the appearance.

In addition, although there is no particular limitation, a degree of sphericity S2 of the second powder coating material is preferably more than 0.94 and 1.00 or less, is more preferably more than 0.95 and 1.00 or less, and is particularly preferably 0.97 to 1.00 from the viewpoint of the adhesiveness between the first layer and the second layer in the obtained coated product and the suppression of color unevenness in the appearance.

Furthermore, a degree of sphericity S2 of the second powder coating material is, for example, preferably 0.97 or more from the viewpoint of the adhesiveness between the first layer and the second layer in the obtained coated product and the suppression of color unevenness in the appearance.

Composition of Powder Coating Material

Hereinbelow, a composition of the first powder coating material and the second powder coating material will be explained.

Unless otherwise specified, in a case of referring to a “powder coating material,” this corresponds to each of the first powder coating material and the second powder coating material.

The powder coating material contains powder particles. If necessary, the powder coating material may have an external additive attached to a surface of the powder particles from the viewpoint of improving fluidity.

In addition, the powder coating material is, for example, preferably a thermosetting powder coating material.

Resin

The powder coating material contains a resin.

In addition, the powder particles preferably contain a resin, for example.

The resin is preferably a thermosetting resin, for example.

A thermosetting resin is a resin having a thermosetting reactive group. Examples of thermosetting resins include various types of resins used in the related art for powder particles of a powder coating material.

The thermosetting resin is, for example, preferably be a water-insoluble (hydrophobic) resin. In a case where the water-insoluble (hydrophobic) resin is used as the thermosetting resin, environmental dependence of charging characteristics of the powder coating material (powder particle) is decreased. In a case of preparing the powder particle by an aggregation and coalescence method, the thermosetting resin is, for example, preferably a water-insoluble (hydrophobic) resin from the viewpoint of realizing emulsification and dispersion in an aqueous medium. The water-insolubility (hydrophobicity) means a dissolved amount of a target material with respect to 100 parts by weight of water at 25° C. is less than 5 parts by weight.

As a thermosetting resin, at least one type selected from the group consisting of a thermosetting polyester resin and a thermosetting (meth)acrylic resin is preferable, for example.

As a thermosetting resin, for example, a thermosetting polyester resin is preferable from the viewpoint of the affinity with a surfactant is higher than that of a thermosetting (meth)acrylic resin, and the surfactant is easily incorporated into the powder particles at the time of manufacturing powder particles by a wet-type method.

Thermosetting Polyester Resin

The thermosetting polyester resin, for example, is a polycondensate obtained by performing at least polycondensation with respect to a polybasic acid and polyhydric alcohol. The thermosetting reaction group of the thermosetting polyester resin is introduced by adjusting the use amount of the polybasic acid and the polyhydric alcohol. According to the adjustment, a thermosetting polyester resin having at least one of a carboxyl group or a hydroxyl group is able to be obtained as the thermosetting reaction group.

Examples of polybasic acid include terephthalic acid, isophthalic acid, phthalic acid, methylterephthalic acid, trimellitic acid, pyromellitic acid, or anhydrides thereof; succinic acid, adipic acid, azelaic acid, sebacic acid, or anhydrides thereof; maleic acid, itaconic acid, or anhydrides thereof; fumaric acid, tetrahydrophthalic acid, methyltetrahydrophthalic acid, hexahydrophthalic acid, methylhexahydrophthalic acid, or anhydrides thereof; cyclohexane dicarboxylic acid, 2,6-naphthalene dicarboxylic acid; and the like.

Examples of polyol include ethylene glycol, diethylene glycol, propylene glycol, dipropylene glycol, 1,3-butanediol, 1,4-butanediol, 1,5-pentanediol, 1,6-hexanediol, neopentyl glycol, triethylene glycol, bis(hydroxyethyl) terephthalate, cyclohexanedimethanol, octanediol, diethylpropane diol, butylethylpropane diol, 2-methyl-1,3-propane diol, 2,2,4-trimethylpentane diol, hydrogenated bisphenol A, an ethylene oxide adduct of hydrogenated bisphenol A, a propylene oxide adduct of hydrogenated bisphenol A, trimethylolethane, trimethylolpropane, glycerin, pentaerythritol, tris-hydroxyethyl isocyanurate, hydroxy pivalyl hydroxy pivalate, and the like.

The thermosetting polyester resin may be obtained by polycondensing other monomer in addition to polybasic acid and polyhydric alcohol. Examples of the other monomer include a compound including both a carboxylic group and a hydroxyl group in one molecule (for example, dimethanol propionic acid and hydroxy pivalate), a monoepoxy compound (for example, glycidyl ester of branched aliphatic carboxylic acid such as “Cardura E10 (manufactured by Shell)”), various monohydric alcohols (for example, methanol, propanol, butanol, and benzyl alcohol), various monovalent basic acids (for example, benzoic acid and p-tert-butyl benzoate), various fatty acids (for example, castor oil fatty acid, coconut oil fatty acid, soybean oil fatty acid, and the like), and the like.

The structure of the thermosetting polyester resin may be a branched structure or a linear structure.

Regarding the thermosetting polyester resin, although there is no particular limitation, the total of an acid value and a hydroxyl value is preferably from 10 mgKOH/g to 250 mgKOH/g, and the number average molecular weight is preferably from 1,000 to 100,000, from the viewpoint of that smoothness of a coated film is excellent.

The measurement of the acid value and the hydroxyl value of the thermosetting polyester resin is performed based on JIS K0070-1992. The molecular weight of the thermosetting polyester resin is measured by gel permeation chromatography (GPC). For molecular weight measurement by GPC, HLC-8120GPC (manufactured by Tosoh Corporation) is used as a measuring device, TSKgel SuperHM-M (15 cm) (manufactured by Tosoh Corporation) is used as a column, and tetrahydrofuran is used as a solvent. The weight-average molecular weight and the number average molecular weight are calculated using a calibration curve of molecular weight created with a monodisperse polystyrene standard sample from results of this measurement.

Thermosetting (Meth)Acrylic Resin

The thermosetting (meth)acrylic resin is a (meth)acrylic resin including a thermosetting reaction group. For the introduction of the thermosetting reaction group to the thermosetting (meth)acrylic resin, a vinyl monomer including a thermosetting reaction group is, for example, preferably be used. The vinyl monomer including a thermosetting reaction group may be a (meth)acrylic monomer (monomer having a (meth)acryloyl group), or may be a vinyl monomer other than the (meth)acrylic monomer.

Examples of the thermosetting reaction group of the thermosetting (meth)acrylic resin include an epoxy group, a carboxylic group, a hydroxyl group, an amide group, an amino group, an acid anhydride group, a (block) isocyanate group, and the like. Among these, as the thermosetting reaction group of the (meth)acrylic resin, at least one kind selected from the group consisting of an epoxy group, a carboxylic group, and a hydroxyl group is, for example, preferable, from the viewpoint of ease of preparation of the (meth)acrylic resin. Particularly, from the viewpoints of excellent storage stability of the powder coating material and coating film appearance, at least one kind of the thermosetting reaction group is, for example, more preferably an epoxy group.

Examples of the vinyl monomer including an epoxy group as the thermosetting reaction group include various chain epoxy group-containing monomers (for example, glycidyl (meth)acrylate, β-methyl glycidyl (meth)acrylate, glycidyl vinyl ether, and allyl glycidyl ether), various (2-oxo-1,3-oxolane) group-containing vinyl monomers (for example, (2-oxo-1,3-oxolane) methyl (meth)acrylate), various alicyclic epoxy group-containing vinyl monomers (for example, 3,4-epoxy cyclohexyl (meth)acrylate, 3,4-epoxycyclohexylmethyl (meth)acrylate, and 3,4-epoxycyclohexylethyl (meth)acrylate), and the like.

Examples of the vinyl monomer including a carboxylic group as the thermosetting reaction group include various carboxylic group-containing monomers (for example, (meth)acrylic acid, crotonicacid, itaconic acid, maleic acid, and fumaric acid), various monoesters of α,β-unsaturated dicarboxylic acid and monohydric alcohol having 1 to 18 carbon atoms (for example, monomethyl fumarate, monoethyl fumarate, monobutyl fumarate, monoisobutyl fumarate, monotert-butyl fumarate, monohexyl fumarate, monooctyl fumarate, mono 2-ethylhexyl fumarate, monomethyl maleate, monoethyl maleate, monobutyl maleate, monoisobutyl maleate, monotert-butyl maleate, monohexyl maleate, monooctyl maleate, and mono 2-ethylhexyl maleate), various monoalkyl ester itaconate (for example, monomethyl itaconate, monoethyl itaconate, monobutyl itaconate, monoisobutyl itaconate, monohexyl itaconate, monooctyl itaconate, and mono 2-ethylhexyl itaconate), and the like.

Examples of the vinyl monomer including a hydroxyl group as the thermosetting reaction group include various hydroxyl group-containing (meth)acrylates (for example, 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, polyethylene glycol mono(meth)acrylate, and polypropylene glycol mono(meth)acrylate), an addition reaction product of the various hydroxyl group-containing (meth)acrylates and ε-caprolactone, various hydroxyl group-containing vinyl ethers (for example, 2-hydroxyethyl vinyl ether, 3-hydroxypropyl vinyl ether, 2-hydroxypropyl vinyl ether, 4-hydroxybutyl vinyl ether, 3-hydroxybutyl vinyl ether, 2-hydroxy-2-methylpropyl vinyl ether, 5-hydroxypentyl vinyl ether, and 6-hydroxyhexyl vinyl ether), an addition reaction product of the various hydroxyl group-containing vinyl ethers and ε-caprolactone, various hydroxyl group-containing allyl ethers (for example, 2-hydroxyethyl (meth)allyl ether, 3-hydroxypropyl (meth)allyl ether, 2-hydroxypropyl (meth)allyl ether, 4-hydroxybutyl (meth)allyl ether, 3-hydroxybutyl (meth)allyl ether, 2-hydroxy-2-methylpropyl (meth)allyl ether, 5-hydroxypentyl (meth)allyl ether, and 6-hydroxyhexyl (meth)allyl ether), an addition reaction product of the various hydroxyl group-containing allyl ethers and ε-caprolactone, and the like.

Examples of (meth)acrylic monomers having no thermosetting reactive group to be a structural unit of a thermosetting (meth)acrylic resin include alkyl ester (meth)acrylate (for example, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-hexyl (meth)acrylate, cyclohexyl (meth)acrylate, 2-ethylhexyl (meth)acrylate, n-octyl (meth)acrylate, isooctyl (meth)acrylate, 2-ethyloctyl (meth)acrylate, dodecyl (meth)acrylate, isodecyl (meth)acrylate, lauryl (meth)acrylate, and stearyl (meth)acrylate), various aryl ester (meth)acrylates (for example, benzyl (meth)acrylate, phenyl (meth)acrylate, and phenoxyethyl (meth)acrylate), various alkyl carbitol (meth)acrylates (for example, ethyl carbitol (meth)acrylate), other various ester (meth)acrylates (for example, isobornyl (meth)acrylate, dicyclopentanyl (meth)acrylate, dicyclopentenyl (meth)acrylate, dicyclopentenyloxyethyl (meth)acrylate, and tetrahydrofurfuryl (meth)acrylate), various amino group-containing amide unsaturated monomers (for example, N-dimethylaminoethyl (meth)acrylamide, N-diethylaminoethyl (meth)acrylamide, N-dimethylaminopropyl (meth)acrylamide, and N-diethylamino propyl (meth)acrylamide), various dialkylaminoalkyl (meth)acrylates (for example, dimethylaminoethyl (meth)acrylate and diethylaminoethyl (meth)acrylate), various amino group-containing monomers (for example, tert-butylaminoethyl (meth)acrylate, tert-butylaminopropyl (meth)acrylate, aziridinylethyl (meth)acrylate, pyrrolidinylethyl (meth)acrylate, and piperidinylethyl (meth)acrylate), and the like.

In the thermosetting (meth)acrylic resin, another vinyl monomer not including a thermosetting reaction group may be copolymerized, in addition to the (meth)acrylic monomer. Examples of the other vinyl monomer include various α-olefins (for example, ethylene, propylene, and butene-1), various halogenated olefins except fluoroolefin (for example, vinyl chloride and vinylidene chloride), various aromatic vinyl monomers (for example, styrene, α-methyl styrene, and vinyl toluene), various diesters of unsaturated dicarboxylic acid and monohydric alcohol having 1 to 18 carbon atoms (for example, dimethyl fumarate, diethyl fumarate, dibutyl fumarate, dioctyl fumarate, dimethyl maleate, diethyl maleate, dibutyl maleate, dioctyl maleate, dimethyl itaconate, diethyl itaconate, dibutyl itaconate, and dioctyl itaconate), various acid anhydride group-containing monomers (for example, maleic anhydride, itaconic anhydride, citraconic anhydride, (meth)acrylic anhydride, and tetrahydrophthalic anhydride), various phosphoric acid ester group-containing monomers (for example, diethyl-2-(meth)acryloyloxyethyl phosphate, dibutyl-2-(meth)acryloyloxybutyl phosphate, dioctyl-2-(meth)acryloyloxyethyl phosphate, and diphenyl-2-(meth)acryloyloxyethyl phosphate), various hydrolyzable silyl group-containing monomers (for example, γ-(meth)acryloyloxypropyl trimethoxysilane, γ-(meth)acryloyloxypropyl triethoxysilane, and γ-(meth)acryloyloxypropyl methyldimethoxysilane), various vinyl aliphatic carboxylate (for example, vinyl acetate, vinyl propionate, vinyl butyrate, vinyl isobutyrate, vinyl caproate, vinyl caprylate, vinyl caprate, vinyl laurate, branched vinyl aliphatic carboxylate having 9 to 11 carbon atoms, and vinyl stearate), various vinyl ester of carboxylic acid having a cyclic structure (for example, cyclohexane carboxylic acid vinyl, methylcyclohexane carboxylic acid vinyl, vinyl benzoate, and p-tert-butyl vinyl benzoate), and the like.

Although there is no particular limitation, the thermosetting (meth)acrylic resin preferably has a number average molecular weight of 1,000 to 20,000, and more preferably has a number average molecular weight of 1,500 to 15,000, from the viewpoint of excellent smoothness of a coated film. The measuring method of the molecular weight of a thermosetting (meth)acrylic resin is the same as that of a thermosetting polyester resin.

Although there is no particular limitation, the thermosetting resin preferably has a glass transition temperature (Tg) of 60° C. or less, and more preferably 55° C. or less, from the viewpoint of excellent smoothness of a coated film even in a case of baking at a low temperature. The glass transition temperature (Tg) of the thermosetting resin is determined from the DSC curve obtained by differential scanning calorimetry (DSC). Specifically, the glass transition temperature is determined by the “extrapolated glass transition start temperature” described in the method of determining the glass transition temperature in JIS K7121-1987 “Method for measuring transition temperature of plastic.”

One kind of a thermosetting resin may be used, or 2 or more kinds thereof may be used in combination.

The content of the thermosetting resin in the powder particles is, for example, preferably 20% by mass to 99% by mass, and is more preferably 30% by mass to 95% by mass.

Other Resins

In a case where the powder particles have a core-shell structure, the core may contain a non-thermosetting resin. However, the proportion of the non-thermosetting resin in the entire resin of the powder particles is, for example, preferably 5% by mass or less, and more preferably 1% by mass or less, from the viewpoint of improving the curing density (crosslinking density) of the coated film. In other words, the resin to be contained in the powder particles is preferably only a thermosetting resin, although there is no particular limitation. The non-thermosetting resin is, for example, preferably at least one selected from the group consisting of (meth)acrylic resins and polyester resins.

Curing Agent

The powder coating material contains a curing agent.

In addition, the powder particles preferably contain a curing agent, for example.

In addition, the curing agent is, for example, preferably a thermal curing agent.

Examples of thermal curing agents include various epoxy resins (for example, polyglycidyl ether of bisphenol A and the like), an epoxy group-containing acrylic resin (for example, glycidyl group-containing acrylic resin and the like), polyglycidyl ethers of various polyhydric alcohols (for example, 1,6-hexanediol, trimethylolpropane, trimethylolethane, and the like), polyglycidyl esters of various polyvalent carboxylic acids (for example, phthalic acid, terephthalic acid, isophthalic acid, hexahydrophthalic acid, methyl hexahydrophthalic acid, trimellitic acid, pyromellitic acid, and the like), various alicyclic epoxy group-containing compounds (for example, bis(3,4-epoxy cyclohexyl)methyl adipate, and the like), hydroxy amide (for example, triglycidyl isocyanurate, β-hydroxyalkyl amide, and the like), and the like.

In addition, examples of thermal curing agents include a blocked isocyanate compound, aminoplast, and the like.

Examples of blocked isocyanate compounds include organic diisocyanates such as various aliphatic diisocyanates (for example, hexamethylene diisocyanate, trimethyl hexamethylene diisocyanate, and the like), various alicyclic diisocyanates (for example, xylylene diisocyanate, isophoronediisocyanate, and the like), and various aromatic diisocyanates (for example, tolylene diisocyanate, 4,4′-diphenylmethane diisocyanate, and the like); an adduct of these organic diisocyanates, and polyhydric alcohol, a low-molecular weight polyester resin (for example, polyester polyol), water, or the like; a polymer of these organic diisocyanates (a polymer including an isocyanurate-type polyisocyanate compound); a compound obtained by blocking various polyisocyanate compounds such as an isocyanate biuret product by a commonly used blocking agent; a self-blocked polyisocyanate compound having a uretdione bond as a structural unit; and the like.

Among them, as a curing agent, for example, a blocked isocyanate compound is preferable, and for example, a blocked polyisocyanate compound is more preferable, from the viewpoint of thermosetting properties and storage stability.

The powder coating material may contain one kind of a curing agent or may contain two or more kinds thereof in combination.

In addition, the powder coating material may contain powder particles which contain only one kind of a curing agent, or may contain powder particles which contain two or more kinds of curing agents. Alternatively, powder particles in which different kinds of curing agents are contained may be used in combination.

A content of the curing agent is, for example, preferably 1% by mass to 30% by mass, and is more preferably 3% by mass to 20% by mass with respect to a content of a thermosetting resin.

Curing Catalyst

Although there is no particular limitation, the powder coating material preferably contains a curing catalyst in the powder particles, and more preferably contains a curing catalyst in a core part of the powder particles, from the viewpoint of a curing temperature and color changes at the time of film formation.

The curing catalyst is not particularly limited, but is preferably at least one compound selected from the group consisting of metal acetylacetonate and quaternary ammonium salts. Incorporation of the at least one compound particularly reduces a decomposition temperature of the thermal curing agent having a uretdione structure.

Specific examples of metal acetylacetonates include aluminum acetylacetonate, chromium acetylacetonate, iron (III) acetylacetonate, zinc (II) acetylacetonate, zirconium (IV) acetylacetonate, and nickel (II)) acetylacetonate.

As a quaternary ammonium salt, although there is no particular limitation, tetraalkyl ammonium salts are preferable; a compound selected from the group consisting of tetraethylammonium salts and tetrabutylammonium salts is more preferable; and a compound selected from the group consisting of tetraethyl ammonium carboxylate, tetraethyl ammonium chloride, tetraethyl ammonium bromide, tetraethyl ammonium fluoride, tetrabutyl ammonium carboxylate, tetrabutyl ammonium chloride, tetrabutyl ammonium bromide, and tetrabutyl ammonium fluoride is even more preferable.

Among them, as the curing catalyst, a compound selected from the group consisting of tetraethylammonium carboxylate and tetrabutylammonium carboxylate is particularly preferable, for example.

The curing catalyst may be used alone or in combination of two or more kinds thereof.

A content of the curing catalyst, for example, preferably, a total content of the metal acetylacetonate and the quaternary ammonium salts, is not limited and is preferably 0.05% by mass to 10% by mass, and is more preferably 0.1% by mass to 5% by mass with respect to a total mass of powder particles. In a case where a content of the curing catalyst is within the above range, changes in color at the time of formation of a coated film becomes smaller.

Colorant

The powder coating material may or may not contain a colorant.

In addition, the powder particles may or may not contain a colorant.

Furthermore, the first powder coating material and the second powder coating material may contain colorants of the same color or may contain colorants of different colors. Among these, although there is no particular limitation, a case in which the first powder coating material contains a colorant and the second powder coating material contains no colorant, or the first powder coating material contains a colorant, and the second powder coating material contains a colorant of a color different from that of the first powder coating material is preferable; a case in which the first powder coating material contains a colorant and the second powder coating material contains no colorant, or the first powder coating material contains a white colorant, and the second powder coating material contains a colorant of a color different from that of the first powder coating material is more preferable; and a case in which the first powder coating material contains a colorant and the second powder coating material contains no colorant is particularly preferable.

The first powder coating material preferably contains a colorant, for example.

In addition, the second powder coating material preferably does not contain a colorant, for example.

As a colorant, a pigment is used, for example. The colorant may use a dye together with a pigment.

Examples of pigments include an inorganic pigment such as iron oxide (for example, colcothar), titanium oxide, titanium yellow, zinc white, white lead, zinc sulfide, lithopone, antimony oxide, cobalt blue, and carbon black; an organic pigment such as quinacridone red, phthalocyanine blue, phthalocyanine green, permanent red, Hansa yellow, Indanthrene Blue, Brilliant Fast Scarlet, and benzimidazolone yellow; and the like.

Other examples of pigments include a glitter pigment. Examples of glitter pigments include metal powder such as a pearl pigment, aluminum powder, and stainless steel powder; metallic flakes; glass beads; glass flakes; mica; micaceous iron oxide (MIO); and the like.

The colorant may be used alone or in combination of two or more kinds thereof.

A content of the colorant is determined depending on types of pigments, and a hue, brightness, and depth required for a coating film, and the like. A content of the colorant is, for example, preferably 1% by mass to 70% by mass and is more preferably 2% by mass to 50% by mass, with respect to the entire resin of a core part and a resin-coated part.

Other Additives

Examples of other additives include various additives used in a powder coating material. Specific examples of other additives include a surface adjusting agent (a silicone oil, an acrylic oligomer, and the like), a foam inhibitor (for example, benzoin, benzoin derivatives, and the like), a hardening accelerator (an amine compound, an imidazole compound, a cationic polymerization catalyst, and the like), a plasticizer, a charge-controlling agent, an antioxidant, a pigment dispersant, a flame retardant, a fluidity-imparting agent, and the like.

Other Components of Powder Particles

The powder particles may contain a divalent or higher valent metal ion (hereinafter, also simply referred to as a “metal ion”). This metal ion is a component contained in both of the core part and the resin-coated part of the powder particles. In a case where a divalent or higher valent metal ion is contained in the powder particles, ionic crosslinking is formed due to the metal ion in the powder particles. For example, in a case where a polyester resin is applied as a thermosetting resin of the core part and a resin of the resin-coated part, a carboxyl group or hydroxy group of the polyester resin interacts with the metal ion to form ionic crosslinking. This ionic crosslinking suppresses bleeding of the powder particles, and storage properties are likely to be improved. In addition, in the ion-crosslinking, the bonding of the ion-crosslinking is broken by heating at the time of thermosetting the powder coating material after being coated, and thus, melt viscosity of the powder particles is low, and a coating film having high smoothness is easily formed.

Examples of metal ions include divalent to tetravalent metal ions. Specific examples of metal ions include at least one kind of metal ions selected from the group consisting of aluminum ion, magnesium ion, iron ion, zinc ion, and calcium ion.

Examples of supply sources of the metal ion (a compound contained in the powder particles as an additive) include a metal salt, an inorganic metal salt polymer, a metal complex, and the like. In a case where the powder particles are produced by an aggregation and coalescence method for example, metal salts and an inorganic metal salt polymer are added to the powder particles as an aggregating agent.

Examples of metal salts include aluminum sulfate, aluminum chloride, magnesium chloride, magnesium sulfate, iron chloride (II), zinc chloride, calcium chloride, calcium sulfate, and the like.

Examples of inorganic metal salt polymers include polyaluminum chloride, polyaluminum hydroxide, polyiron sulfate (II), calcium polysulfide, and the like.

Examples of metal complexes include metal salts of an aminocarboxylic acid, and the like. Specific examples of metal complexes include metal salts (for example, calcium salts, magnesium salts, iron salts, aluminum salts, and the like) containing a known chelate as a base, such as an ethylenediaminetetraacetic acid, a propanediaminetetraacetic acid, a nitriletriacetic acid, a triethylenetetraminehexaacetic acid, and a diethylenetriaminepentaacetic acid; and the like.

A supply source of these metal ions may be added not as an aggregating agent but as a mere additive.

A higher valence of the metal ion is, for example, preferable from the viewpoint of easy formation of mesh-shaped ionic crosslinking, smoothness of a coating film, and storing properties of a powder coating material. For this reason, Al ion is, for example, preferable as the metal ion. In other words, aluminum salts (for example, aluminum sulfate, aluminum chloride, and the like) and an aluminum salt polymer (for example, polyaluminum chloride, polyaluminum hydroxide, and the like) are, for example preferable as the supply source of the metal ion. Furthermore, among the supply sources of the metal ion, an inorganic metal salt polymer is, for example, preferable as compared to metal salts even in a case of the same valence of the metal ion, from the viewpoint of smoothness of a coating film and storing properties of a powder coating material. For this reason, the aluminum salt polymer (for example, the polyaluminum chloride, the polyaluminum hydroxide, and the like) is, for example, particularly preferable as the supply source of the metal ion.

Although there is no particular limitation, a content of the metal ion is preferably 0.002% by mass to 0.2% by mass, and is more preferably 0.005% by mass to 0.15% by mass with respect to a total content of the powder particles, from the viewpoint of smoothness of a coating film and storing properties of a powder coating material.

In a case where a content of the metal ion is 0.002% by mass or more, suitable ionic crosslinking is formed due to the metal ion, bleeding of the powder particles is suppressed, and storing properties of a coating material are easily improved. On the other hand, in a case where a content of the metal ion is 0.2% by mass or less, ionic crosslinking is suppressed from being excessively formed due to the metal ion, and smoothness of a coating film is easily improved.

In a case where the powder particles are produced by an aggregation and coalescence method, the supply source of the metal ion (metal salts and a metal salt polymer) added as an aggregating agent contributes to control a particle diameter distribution and a shape of the powder particles.

Specifically, a higher valence of the metal ion is, for example, preferable from the viewpoint of obtaining a narrow particle diameter distribution. In addition, the metal salt polymer is, for example, preferable as compared to the metal salts even in a case of the same valence of the metal ion, from the viewpoint of obtaining a narrow particle diameter distribution. For this reason, from this viewpoint, although there is no particular limitation, the aluminum salts (for example, aluminum sulfate, aluminum chloride, and the like) and the aluminum salt polymer (for example, polyaluminum chloride, polyaluminum hydroxide, and the like) are preferable, and the aluminum salt polymer (for example, the polyaluminum chloride, the polyaluminum hydroxide, and the like) is particularly preferable, as the supply source of the metal ion.

In addition, in a case where an aggregating agent is added such that a content of the metal ion becomes 0.002% by mass or more, aggregation of resin particles in an aqueous medium progresses, and therefore this case contributes to realization of a narrow particle diameter distribution. In addition, aggregation of resin particles which become the resin-coated part progresses with respect to aggregated particles which become the core part, and therefore, this case contributes to realization of formation of the resin-coated part with respect to the entire surface of the core part. On the other hand, in a case where an aggregating agent is added such that a content of the metal ion becomes 0.2% by mass or less, ionic crosslinking is suppressed from being excessively generated in the aggregated particles, and a shape of the powder particles to be generated easily becomes a shape close to a spherical shape at the time of aggregation and coalescence. For this reason, from these viewpoint, although there is no particular limitation, a content of the metal ion is preferably 0.002% by mass to 0.2% mass, and is more preferably 0.005% by mass to 0.15% by mass.

A content of the metal ion is measured by performing quantitative analysis on an intensity of a fluorescent X ray of the powder particles. Specifically, for example, first, a resin and the supply source of the metal ion are mixed, and therefore a resin mixture in which a concentration of the metal ion is known is obtained. A pellet sample is obtained from 200 mg of this resin mixture by using a molding machine of a tablet having a diameter of 13 mm. A mass of this pellet sample is weighed, an intensity of a fluorescent X ray of the pellet sample is measured, and therefore a peak intensity is obtained. Similarly, measurement is performed on a pellet sample in which an amount of the supply source added of the metal ion is changed, and a calibration curve is created from the results thereof. Then, a content of the metal ions in the powder particles which are a measurement target is quantitatively analyzed by using this calibration curve.

Examples of adjustment methods of a content of the metal ion include a method 1) in which an amount of the supply source added of the metal ion is adjusted; a method 2) in which in a case where the powder particles are produced by an aggregation and coalescence method, an aggregating agent (for example, the metal salts or the metal salt polymer) is added as the supply source of the metal ion in an aggregation step, and thereafter, a chelating agent (for example, an ethylene diamine tetraacetic acid (EDTA), a diethylene triamine pentaacetic acid (DTPA), a nitrilotriacetic acid (NTA), and the like) is added in a final stage of the aggregation step to form a complex with the metal ion by the chelating agent, complex salts formed in the subsequent washing step or the like are removed, and therefore a content of the metal ions is adjusted; and the like.

External Additives

The powder coating material may contain an external additive.

External additive suppresses generation of aggregation between powder particles. Accordingly, a coated film with a high level of smoothness can be formed with a small amount of powder coating material. Specific examples of external additives include inorganic particles. Examples of inorganic particles include particles such as SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, and MgSO₄.

The surface of the inorganic particles as an external additive is, for example, preferably subjected to a hydrophobization treatment. The hydrophobization treatment is performed by, for example, immersing inorganic particles in a hydrophobization treatment agent. The hydrophobization treatment agent is not particularly limited, and examples thereof include a silane-based coupling agent, silane, a silicone oil, a titanate-based coupling agent, and an aluminum-based coupling agent. These may be used alone or in combination of two or more kinds thereof. An amount of the hydrophobization treatment agent is, for example, 1 part by mass to 10 parts by mass with respect to 100 parts by mass of the inorganic particles.

A volume average particle diameter of an external additive is, for example, preferably 5 nm to 40 nm, and is more preferably 8 nm to 30 nm, although there is no particular limitation. By using an external additive having a volume average particle diameter of 5 nm to 40 nm, in a case of applying a powder coating material with a spray gun or the like, the powder particles are loosened by an air flow and easily fly as primary particles, and therefore the particles can adhere to the substrate in the form of primary particles.

An external addition amount of the external additive is, for example, preferably 0.01% by mass to 5% by mass %, and is more preferably 0.01% by mass to 2.0% by mass % with respect to a total mass of a powder coating material.

Melting Temperature of Powder Coating Material

Although there is no particular limitation, a melting temperature in a ½ method of the powder coating material is preferably 90° C. to 125° C., and is more preferably 100° C. to 115° C., from the viewpoint of smoothness of a coating film and a decrease in a baking temperature.

A softening point of the powder coating material is measured by using a tubular rheometer of constant load extrusion type, “flow characteristic evaluation device Flow Tester CFT-500D” (manufactured by Shimadzu Corporation) according to a manual attached to the device. In this device, while applying a constant load from the top part of a measurement sample by a piston, the measurement sample filled in a cylinder is heated and melted, the melted measurement sample is extruded from a die at the bottom part of the cylinder, and therefore it is possible to obtain a flow curve that indicates the relationship between an amount of piston depression and a temperature at this time.

In the present embodiment, a “melting temperature in the ½ method” described in the manual attached to the “flow characteristic evaluation device Flow Tester CFT-500D” is taken as a softening point. A melting temperature in the ½ method is calculated as follows. First, ½ of a difference between an amount of drop Smax of the piston when outflow is completed, and an amount of drop Smin of the piston when the outflow is started is obtained (which is taken as X). X=(Smax−Smin)/2). Then, a temperature of a flow curve when an amount of drop of the piston in the flow curve becomes a sum of X and Smin is a melting temperature Tm in the ½ method.

About 1.0 g of a sample is compression molded at about 10 MPa for about 60 seconds under an environment of 25° C. using a tablet molding and compression machine (for example, NT-100H, manufactured by NPa SYSTEM CO., LTD.), and a cylindrical sample having a diameter of about 8 mm is used.

The measurement conditions of CFT-500D are as follows.

Test mode: Temperature rising method

Starting temperature: 50° C.

End-point temperature: 200° C.

Measurement interval: 1.0° C.

Heating rate: 4.0° C./min

Piston cross-sectional area: 1,000 cm²

Test load (piston load): 10.0 kgf (0.9807 MPa)

Preheating time: 300 seconds

Hole diameter of die: 1.0 mm

Length of die: 1.0 mm

Peak Temperature of Exothermic Peak of Powder Coating Material

A peak temperature of an exothermic peak in differential scanning calorimetry (DSC measurement) of the powder coating material is, for example, preferably within a range of 40° C. to 100° C., and is more preferably within a range of 50° C. to 80° C., from the viewpoint of smoothness of a coating film and a decrease in a baking temperature.

The measurement of the exothermic peak in differential scanning calorimetry (DSC measurement) is performed as follows.

A sample is set on a differential scanning calorimeter (DSC-50, manufactured by Shimadzu Corporation) equipped with an automatic tangent processing system, liquid nitrogen is set as a cooling medium, and heat is performed from 0° C. to 200° C. at a heating rate of 10° C./rain, and therefore a DSC curve is obtained. A peak temperature of the exothermic peak in the obtained DSC curve is obtained as a measurement value.

A melting temperature of the mixture of indium and zinc is used for temperature correction of a detection unit of the measuring device, and melting heat of indium is used for heat correction. A sample is put in an aluminum pan, the aluminum pan in which the sample is put and an empty aluminum pan for the control are set.

Method for Manufacturing Powder Coating Material

Next, a method for manufacturing the powder coating material will be described.

The powder coating material is obtained by, after manufacturing powder particles, externally adding external additives to the powder particles as necessary.

The powder particles may be manufactured by any of a dry manufacture method (for example, a kneading and pulverizing method and the like), and a wet-type manufacture method (for example, aggregation and coalescence method, a suspension and polymerization method, a dissolution and suspension method, and the like). The method for manufacturing powder particles is not particularly limited to these manufacture methods, and known manufacture methods are employed.

Among these, for example, it is preferable to obtain powder particles by an aggregation and coalescence method from the viewpoint of easy control of a volume average particle size distribution index GSDv and an average circularity within the above-mentioned range.

Hereinafter, the details of each of the steps will be described.

In the following description, a method for manufacturing powder particles containing a colorant will be described, but the colorant is contained therein if necessary.

Preparing Step of Each Dispersion Liquid

First, each dispersion liquid to be used in the aggregation and coalescence method is prepared. Specifically, a resin particle dispersion liquid in which specific acrylic resin particles are dispersed, a curing agent dispersion liquid in which a curing agent is dispersed, and a colorant dispersion liquid in which a colorant is dispersed are prepared.

Herein, a resin particle dispersion liquid is prepared by, for example, dispersing resin particles in a dispersion medium with a surfactant.

Examples of dispersion media used in the resin particle dispersion liquid include an aqueous medium.

Examples of aqueous media include water such as distilled water and ion exchange water; alcohols; and the like. The medium may be used alone or in combination of two or more kinds thereof.

Examples of surfactants include anionic surfactants such as sulfuric ester salt, sulfonate, phosphate ester, and soap anionic surfactants; cationic surfactants such as amine salt and quaternary ammonium salt cationic surfactants; nonionic surfactants such as polyethylene glycol, alkyl phenol ethylene oxide adduct, and polyol nonionic surfactants; and the like. Among these, anionic surfactants and cationic surfactants are particularly used. Nonionic surfactants may be used in combination with anionic surfactants or cationic surfactants.

The surfactants may be used alone or in combination of two or more kinds thereof.

Regarding the resin particle dispersion liquid, examples of methods of dispersing resin particles in a dispersion medium include a general dispersing method using, for example, a rotary shearing-type homogenizer, or a ball mill, a sand mill, or a Dyno mill having media. Depending on types of resin particles, resin particles may be dispersed in the resin particle dispersion liquid by using, for example, a phase inversion emulsification method.

The phase inversion emulsification method includes: dissolving a resin to be dispersed in a hydrophobic organic solvent in which the resin is soluble; conducting neutralization by adding a base to an organic continuous phase (O phase); and converting the resin (so-called phase inversion) from W/O to O/W by adding an aqueous medium (W phase) to form a discontinuous phase, thereby dispersing the resin as particles in the aqueous medium.

As a method for manufacturing a resin particle dispersion liquid, specifically, for example, in a case of an acrylic resin particle dispersion liquid, a resin particle dispersion liquid in which acrylic resin particles are dispersed is obtained by emulsifying a raw material monomer in water in an aqueous medium, adding a water-soluble initiator, and if necessary, a chain transfer agent for molecular weight control and heating the mixture, and performing emulsion polymerization.

In addition, in a case of a polyester resin particle dispersion liquid, a resin particle dispersion liquid in which polyester resin particles are dispersed is obtained by heating and melting a raw material monomer and by polycondensing the raw material monomer under reduced pressure, and then by adding the obtained polycondensate to a solvent (for example, ethyl acetate and the like) and by dissolving the polycondensate in the solvent, and furthermore, by stirring the obtained dissolved material while adding a weak alkaline aqueous solution thereinto, and by performing phase inversion and emulsion with respect to the dissolved material.

In a case of obtaining a composite particle dispersion liquid, the composite particle dispersion liquid is obtained by mixing a resin and a thermal curing agent and dispersing the mixture in a dispersion medium (for example, performing emulsification such as phase inversion and emulsion).

Although there is no particular limitation, a volume average particle diameter of the resin particles dispersed in the resin particle dispersion liquid is preferably 1 μm or less, is more preferably 0.01 μm to 1 μm, is even more preferably 0.08 μm to 0.8 μm, and is particularly preferably 0.1 μm to 0.6 μm.

Regarding the volume average particle diameter of the resin particles, a cumulative distribution by volume is drawn from the side of the smallest diameter with respect to particle size ranges (channels) separated using the particle diameter distribution obtained by the measurement with a laser diffraction-type particle diameter distribution measuring device (for example, LA-700 manufactured by Horiba, Ltd.), and a particle diameter when the cumulative percentage becomes 50% with respect to the entire particles is measured as a volume average particle diameter D₅₀ᵥ. The volume average particle diameter of the particles in other dispersion liquids is also measured in the same manner.

The content of the resin particles contained in the resin particle dispersion liquid is, for example, preferably from 5% by weight to 50% by weight, and more preferably from 10% by weight to 40% by weight.

For example, the curing agent dispersion liquid and the colorant dispersion liquid are also prepared in the same manner as in the case of the resin particle dispersion liquid. That is, the volume average particle diameter, the dispersion medium, the dispersing method, and the content of the particles of the colorant dispersed in the colorant dispersion liquid and the particles of the curing agent dispersed in the curing agent dispersion liquid are the same as those of the resin particles in the resin particle dispersion.

Aggregated Particle Forming Step

Next, the resin particle dispersion liquid, the curing agent dispersion liquid, and, if necessary, the colorant dispersion liquid are mixed with each other.

The specific acrylic resin particles, the curing agent, and the colorant are heterogeneously aggregated in the mixed dispersion liquid, thereby forming aggregated particles having a diameter near a target powder particle diameter and including the specific acrylic resin, the curing agent, and the colorant.

Specifically, for example, an aggregating agent is added to the mixed dispersion liquid and a pH of the mixed dispersion liquid is adjusted to be acidic (for example, the pH is from 2 to 5). If necessary, a dispersion stabilizer is added. Then, the mixed dispersion liquid is heated at a temperature of a glass transition temperature of the resin particles (specifically, for example, from a temperature 30° C. lower than the glass transition temperature of the resin particles to a temperature 10° C. lower than the glass transition temperature thereof) to aggregate the particles dispersed in the mixed dispersion liquid, thereby forming the aggregated particles.

In the aggregated particle forming step, the aggregated particles may be formed by mixing the composite particle dispersion liquid including the specific acrylic resin and the curing agent, and the colorant dispersion liquid with each other and heterogeneously aggregating the composite particles and the colorant in the mixed dispersion liquid.

In the aggregated particle forming step, for example, the aggregating agent may be added at room temperature (for example, 25° C.) while stirring of the mixed dispersion liquid using a rotary shearing-type homogenizer, the pH of the mixed dispersion liquid may be adjusted to be acidic (for example, the pH is from 2 to 5), a dispersion stabilizer may be added if necessary, and the heating may then be performed.

Examples of the aggregating agent include a surfactant having an opposite polarity to the polarity of the surfactant used as the dispersant to be added to the mixed dispersion liquid, metal salt, a metal salt polymer, and a metal complex. When a metal complex is used as the aggregating agent, the amount of the surfactant used is reduced and charging characteristics are improved.

After completing the aggregation, an additive for forming a complex or a similar bond with metal ion of the aggregating agent may be used, if necessary. A chelating agent is, for example, used as this additive. With the addition of this chelating agent, the content of the metal ion of the powder particles may be adjusted, when the aggregating agent is excessively added.

Herein, the metal salt, the metal salt polymer, or the metal complex as the aggregating agent is used as a supply source of the metal ions. These examples are as described above.

A water-soluble chelating agent is used as the chelating agent. Specific examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent added may be, for example, from 0.01 parts by weight to 5.0 parts by weight, and is preferably from greater than or equal to 0.1 parts by weight and less than 3.0 parts by weight with respect to 100 parts by weight of the resin particles.

Coalescence Union Step

Next, the aggregated particle dispersion liquid in which the aggregated particles are dispersed is heated at, for example, a temperature that is higher than or equal to the glass transition temperature of the resin particles (for example, a temperature that is higher than the glass transition temperature of the resin particles by 10° C. to 30° C.) to coalesce the aggregated particles and form the powder particles.

The powder particles are obtained through the foregoing step.

Herein, after the coalescence step ends, the powder particles formed in the dispersion liquid are subjected to a washing step, a solid-liquid separation step, and a drying step, that are well known, and thus, dry powder particles are obtained.

In the washing step, for example, preferably displacement washing using ion exchange water is sufficiently performed from the viewpoint of charging properties. In addition, the solid-liquid separation step is not particularly limited, but suction filtration, pressure filtration, or the like is preferably performed from the viewpoint of productivity. The method for the drying step is also not particularly limited, but freeze drying, airflow drying, fluidized drying, vibration-type fluidized drying, or the like is preferably performed from the viewpoint of productivity.

In addition, the powder coating material is manufactured by, for example, adding and mixing external additives with the obtained powder particles in a dry state as necessary. Mixing is preferably performed with, for example, a V-BLENDER, a HENSCHEL MIXER, an LODIGE MIXER, or the like. Furthermore, if necessary, coarse particles of a toner may be removed using a vibration sieving machine, a wind classifier, or the like.

Method for Manufacturing Coated Product

The method for manufacturing a coated product according to the present exemplary embodiment is not particularly limited, but a method including applying a first powder coating material on a substrate; applying a second powder coating material on the first powder coating material applied; and heating and curing the first powder coating material and the second powder coating material applied, in which the first powder coating material and the second powder coating material in the powder coating material set according to the present exemplary embodiment are used as the first powder coating material and the second powder coating material, is preferable, although there is no particular limitation.

The substrate, the first powder coating material, and the second powder coating material in the method for manufacturing a coated product according to the present exemplary embodiment are same as the above-described substrate, the first powder coating material, and the second powder coating material, and a preferable aspect thereof is also the same.

A method for applying a powder coating material in the step of applying the first powder coating material and the step of applying the second powder coating material is not particularly limited, and the coating may be performed by known coating methods or a coating method.

In addition, as a method of applying the first powder coating material and the second powder coating material, electrostatic powder coating, triboelectric powder coating, fluid immersion, and the like are preferable, for example. Furthermore, the first powder coating material and the second powder coating material may be applied by the same application method or may be applied by different application methods.

The application amounts of the first powder coating material and the second powder coating material are, for example, preferably adjusted to satisfy a preferable range of T1/T2 described above, although there is no particular limitation.

In the curing step, although there is no particular limitation, it is preferable to cure the first powder coating material and the second powder coating material by one heating.

The heating temperature (baking temperature) in the curing step may be appropriately selected according to the composition and the like of the first powder coating material and the second powder coating material to be used, but the temperature is preferably 90° C. to 250° C., is more preferably 100° C. to 220° C., and is even more preferably 120° C. to 200° C., although there is no particular limitation. The heating time (baking time) is not particularly limited, and may be adjusted by the heating temperature (baking temperature).

Furthermore, the method for manufacturing a coated product according to the present exemplary embodiment may include other step other than those described above, if desired.

Other steps include known steps.

### Examples

Hereinafter, the present exemplary embodiment will be described in detail with reference to examples, and the present exemplary embodiment is not limited to the examples. Furthermore, in the following description, unless otherwise particularly stated, both of “parts” and “%” are based on a mass.

In addition, a volume average particle diameter and a degree of sphericity of each powder coating material, a degree of interface roughness Ra between a first layer and a second layer, an average layer thickness of the first layer and the second layer, a surface roughness Ra of a surface of a coated product, and a surface coverage of a coated film layer are measured by the method described above.

The raw materials used are shown below.

Resin Composition

CRYLCOAT 1716-0 (manufactured by Daicel Cytech Co., Ltd., polyester resin, acid value: 30 mg KOH/g)

Curing Agent

Block Isocyanate Curing Agent VESTAGONB1530 (manufactured by Evonik Japan Co., Ltd.)

Titanium Oxide

JR-701 (manufactured by Tayca Co., Ltd., average particle diameter: 0.27 μm, content of titanium oxide: 93% or more)

Surface Conditioner

REGIFLOW P67 (manufactured by Estron Chemical Co., Ltd., surface conditioner, acrylic copolymer)

Black Pigment

Carbon black (manufactured by Orion engineered carbon, NIPEX)

Each raw material is subjected to pre-mixing at 3,000 rpm for 30 seconds using a mixer (Super Mixer Piccolo, manufactured by Kawata Co., Ltd.) according to the formulation (unit: parts by mass) shown in Table 1. Subsequently, kneading is performed at 115° C. and 90 rpm using a co-kneader (PCS30, manufactured by BUSS Company). Thereafter, operations of solidification, pulverization, and classification of the melt-kneaded product are carried out. Table 1 shows a volume average particle diameter and a degree of sphericity.

TABLE 1

| Powder coating material | 1A | 1B | 1C |
|---|---|---|---|
| CRYLCOAT 1716-0 | 80 | 80 | 57.3 |
| Blocked isocyanate | 15.3 | 15.3 | 12 |
| JR-701 | — | — | 30 |
| REGIFLOW P67 | 0.7 | 0.7 | 0.7 |
| Carbon black | 4 | 4 | |
| Volume average particle diameter | 44 | 23 | 30 |
| D1 (μm) | | | |
| Sphericity S1 | 0.94 | 0.94 | 0.92 |

Preparation of Colorant Dispersion Liquid W
Titanium oxide (CR-60 manufactured by ISHIHARA SANGYO KAISHA, LTD.): 200 parts
Anionic surfactant (NEOGEN RK manufactured by DKS Co. Ltd.): 10 parts
Ion exchange water: 300 parts
Aqueous solution of 1.0% by mass of nitric acid: 15 parts

The above materials and 600 parts of 3 mm diameter alumina beads (manufactured by As One) are charged into a bottle (I-Boy, manufactured by As One) and mixed in a table ball mill at 150 rpm for 24 hours, ion exchange water is added thereto to adjust a concentration of solid contents to 25% by mass, and therefore a colorant dispersion liquid W is obtained. In the colorant dispersion liquid W, a volume average particle diameter of the titanium oxide pigment is 350 nm.

Preparation of Colorant Dispersion Liquid R
Magenta pigment (manufactured by BASF SE, Pigment Red 282 (PR282), Irgazin (trademark) Magenta 2012): 50 parts
Anionic surfactant (manufactured by Tayca Co., Ltd., Tayka Power): 4 parts
Ion exchange water: 150 parts

The above pigment, surfactant, and ion exchange water are mixed, dissolved, and dispersed for 2 hours using a high-pressure disperser (manufactured by Sugino Machine Co., Ltd., Ultimizer HPJ30006), and therefore a pigment dispersion liquid I obtained by dispersing a pigment is obtained. Ion exchange water is added so that a solid content in the dispersion liquid becomes 20% by mass, and a colorant dispersion liquid R in which colorant particles having a volume average particle diameter of 140 nm is obtained.

Preparation of Polyester Resin (PES1)
Terephthalic acid: 30 molar parts
Dodecenyl succinic anhydride: 20 molar parts
Bisphenol A propylene oxide 2 molar adduct: 15 molar parts
Bisphenol A ethylene oxide 2 molar adduct: 10 molar parts
Propylene glycol: 25 molar parts

The above materials are charged into a reaction vessel equipped with a stirrer, a thermometer, a nitrogen gas inlet, and a rectification column, and a temperature is raised to 240° C. while stirring under a nitrogen atmosphere to carry out a polycondensation reaction. A weight-average molecular weight of amorphous polyester resin (APES1) is 23,000 and an acid value is 16.

Preparation of Resin Particle Dispersion Liquid

A mixed solvent of 300 parts by mass of ethyl acetate and 30 parts by mass of isopropyl alcohol is put into a reaction vessel (BJ-30N, manufactured by TOKYO RIKAKIKAI CO, LTD.) provided with a jacket which includes a condenser, a thermometer, a water dropping device, and an anchor blade while maintaining the reaction vessel at 40° C. in a water circulation type thermostatic bath, and the following materials are put into the reaction vessel.
Amorphous polyester resin (PES1): 240 parts
Thermal curing agent: Blocked isocyanate curing agent VESTAGONB1530 (manufactured by Evonik Japan Co., Ltd.): 60 parts
Antifoaming agent: Benzoin: 1.5 parts
Surface conditioner: Acrylic oligomer (ACRONAL 4F manufactured by BASF SE): 3 parts

After putting the above materials into the reaction vessel, the mixture is stirred at a rotation speed of 150 rpm using a three-one motor to dissolve the materials, and therefore an oil phase is obtained. 30 parts of an ammonia aqueous solution of 10% by weight is dropped into the oil phase being stirred, over 5 minutes and is mixed for 10 minutes, and then, 900 parts of ion exchange water is further dropped thereinto at a rate of 5 parts per a minute, and thus, a phase inversion is performed to thereby obtain an emulsion liquid.

Immediately, 800 parts of the obtained emulsified liquid and 700 parts of ion exchange water are put into an eggplant flask, are set in an evaporator provided with a vacuum control unit (manufactured by TOKYO RIKAKIKAI CO, LTD.) through a trap bulb. The eggplant flask is heated in a hot water bath at 60° C. while rotating the flask, and a solvent is removed by reducing a pressure to 7 kPa while being careful of bumping. When a recovery amount of the solvent becomes 1,100 parts, the pressure returns to the normal pressure, and the eggplant flask is cooled to obtain a resin particle dispersion liquid containing a polyester resin PES1 and a thermal curing agent. There is no solvent odor in the obtained dispersion liquid.

Thereafter, 2% by weight of an anionic surfactant (Dowfax2A1 manufactured by The Dow Chemical Company, an amount of effective component: 45% by weight) is added and mixed as an effective component with respect to a resin content in the dispersion liquid, and adjustment is performed such that a concentration of solid contents becomes 25% by weight by adding ion exchange water thereto. This is used as a first resin particle dispersion liquid. A volume average particle diameter of the first resin particles in the first resin particle dispersion liquid is 150 nm.

Production of Powder Coating Material 2A

Aggregation Step
Resin particle dispersion liquid: 180 parts by mass (solid content: 45 parts by mass)
Colorant dispersion liquid R: 20 parts by mass (solids content: 4 parts by mass)
Colorant dispersion liquid W: 150 parts by mass (solids content: 37.5 parts by mass)
Ion exchange water: 100 parts by mass

The above components are thoroughly mixed and dispersed in a round stainless steel flask with a homogenizer (ULTRA-TURRAX T50, manufactured by IKA Works GmbH & Co.). Next, a pH is adjusted to 2.8 by using an aqueous solution of 1.0% nitric acid. 0.70 parts of an aqueous solution of 10% polyaluminum chloride are added thereto, and a dispersing operation is continuously performed by using ULTRA-TURRAX.

A stirrer and a mantle heater are installed, a temperature is raised up to 53° C. while appropriately adjusting a rotation speed of the stirrer such that slurry is sufficiently stirred, the slurry is maintained at 53° C. for 15 minutes, and then when a volume average particle diameter becomes 7.5 μm, 100 parts by mass of the resin particle dispersion liquid is slowly charged.

Coalescence Union Step

After maintaining for 30 minutes after the addition, a pH is adjusted to 7.7 by using an aqueous solution of 5% of sodium hydroxide. Thereafter, a temperature is raised up to 90° C. and maintained for 2 hours. A nearly spherical shape is observed with an optical microscope.

Filtering Step, Washing Step, and Drying Step

After the reaction ends, a solution in the flask is cooled and is filtered, and therefore a solid content is obtained. Next, this solid content is sufficiently washed with ion exchange water, and then, solid liquid separation is performed by Nutsche type suction filtration, and therefore a solid content is obtained again.

Next, this solid content is dispersed again in 3,000 parts by mass of ion exchange water at 40° C., and stirred at 300 rpm for 15 minutes, and washed. The washing operation is repeated 5 times, the solid content obtained by performing the solid liquid separation by the Nutsche type suction filtration is subjected to vacuum drying for 12 hours.

The powder particles of this colored powder coating material have a volume average particle diameter D₅₀ᵥ of 8.5 μm and a degree of sphericity of 0.99.

External Addition of External Additives

0.5 parts by mass of hydrophobic silica (a primary particle diameter of 12 nm) are mixed with 100 parts by mass of these powder particles, and therefore a red powder coating material 2A made of polyester resin is obtained.

Production of Powder Coating Material 2B

A powder coating material 2B is obtained in the same manner as in the production of the powder coating material 2A except that in the aggregation step, a temperature is raised up to 56° C., the slurry is maintained at 56° C. for 15 minutes, and then when a volume average particle diameter becomes 10 μm, 100 parts by mass of the resin particle dispersion liquid is slowly charged. A volume average particle diameter D₅₀ᵥ is 11.1 μm and a degree of sphericity is 0.97.

Production of Powder Coating Material 2C

A powder coating material 2C is obtained in the same manner as in the production of the powder coating material 2A except that in the aggregation step, a temperature is raised up to 58° C., the slurry is maintained at 58° C. for 15 minutes, and then when a volume average particle diameter becomes 13.5 μm, 100 parts by mass of the resin particle dispersion liquid is slowly charged. A volume average particle diameter D₅₀ᵥ is 14.7 μm and a degree of sphericity is 0.97.

Production of Powder Coating Material 2D

Aggregation Step
Resin particle dispersion liquid: 250 parts by mass (solid content: 62.5 parts by mass)
Ion exchange water: 100 parts by mass

The above components are thoroughly mixed and dispersed in a round stainless steel flask with a homogenizer (ULTRA-TURRAX T50, manufactured by IKA Works GmbH & Co.). Next, a pH is adjusted to 2.8 by using an aqueous solution of 1.0% nitric acid. 0.70 parts of an aqueous solution of 10% polyaluminum chloride are added thereto, and a dispersing operation is continuously performed by using ULTRA-TURRAX.

A stirrer and a mantle heater are installed, a temperature is raised up to 52° C. while appropriately adjusting a rotation speed of the stirrer such that slurry is sufficiently stirred, the slurry is maintained at 52° C. for 15 minutes, and then when a volume average particle diameter becomes 5.7 μm, 100 parts by mass of the resin particle dispersion liquid is slowly charged.

Coalescence Union Step

After maintaining for 30 minutes after the addition, a pH is adjusted to 7.7 by using an aqueous solution of 5% of sodium hydroxide. Thereafter, a temperature is raised up to 90° C. and maintained for 2 hours. A nearly spherical shape is observed with an optical microscope.

Filtering Step, Washing Step, and Drying Step

After the reaction ends, a solution in the flask is cooled and is filtered, and therefore a solid content is obtained. Next, this solid content is sufficiently washed with ion exchange water, and then, solid liquid separation is performed by Nutsche type suction filtration, and therefore a solid content is obtained again.

Next, this solid content is dispersed again in 3,000 parts by mass of ion exchange water at 40° C., and stirred at 300 rpm for 15 minutes, and washed. The washing operation is repeated 5 times, the solid content obtained by performing the solid liquid separation by the Nutsche type suction filtration is subjected to vacuum drying for 12 hours.

The powder particles of this clear powder coating material have a volume average particle diameter D₅₀ᵥ of 6.2 μm and a degree of sphericity of 0.99.

External Addition of External Additives

0.5 parts by mass of hydrophobic silica (a primary particle diameter of 12 nm) are mixed with 100 parts by mass of these powder particles, and therefore a clear powder coating material 2D made of polyester resin is obtained.

Production of Powder Coating Material 2E

A powder coating material 2E is obtained in the same manner as in the production of the powder coating material 2D except that in the aggregation step, a temperature is raised up to 57° C., the slurry is maintained at 57° C. for 15 minutes, and then when a volume average particle diameter becomes 10 μm, 100 parts by mass of the resin particle dispersion liquid is slowly charged. A volume average particle diameter D₅₀ᵥ is 10.2 μm and a degree of sphericity is 0.98.

Production of Powder Coating Material 2F

A powder coating material 2F is obtained in the same manner as in the production of the powder coating material 2D except that in the aggregation step, a temperature is raised up to 59° C., the slurry is maintained at 59° C. for 15 minutes, and then when a volume average particle diameter becomes 13 μm, 100 parts by mass of the resin particle dispersion liquid is slowly charged. A volume average particle diameter D₅₀ᵥ is 14.2 μm and a degree of sphericity is 0.97.

Production of Powder Coating Material 2G

A powder coating material 2G is obtained in the same manner as in the production of the powder coating material 2D except that in the aggregation step, a temperature is raised up to 60° C., the slurry is maintained at 60° C. for 15 minutes, and then when a volume average particle diameter becomes 14.3 μm, 100 parts by mass of the resin particle dispersion liquid is slowly charged. A volume average particle diameter D₅₀ᵥ is 15.3 μm and a degree of sphericity is 0.97.

Production of Powder Coating Material 2H

Preparation of Thermosetting Acrylic Resin Particle Dispersion Liquid (A1)
Styrene: 60 parts by mass
Methyl methacrylate: 240 parts by mass
Hydroxyethyl methacrylate: 50 parts by mass
Carboxyethyl acrylate: 18 parts by mass
Glycidyl methacrylate: 260 parts by mass
Dodecanethiol: 8 parts by mass

The above components are mixed and dissolved to prepare a monomer solution A.

Meanwhile, 12 parts by mass of an anionic surfactant (DOWFAX, manufactured by The Dow Chemical Company) is dissolved in 280 parts by mass of ion exchange water, the above monomer solution A is added thereto, and the mixture is dispersed in a flask and emulsified to obtain a solution (monomer emulsified liquid A).

Next, 1 part by mass of an anionic surfactant (DOWFAX, manufactured by The Dow Chemical Company) is dissolved in 555 parts by mass of ion exchange water, and charged into a polymerization flask. Thereafter, the polymerization flask is tightly sealed, a recirculating pipe is installed, and the polymerization flask is heated to 75° C. with a water bath and maintained while introducing nitrogen and while slowly stirring.

In this state, 9 parts by mass of ammonium persulfate are dissolved in 43 parts by mass of ion exchange water and added dropwise into the polymerization flask through a metering pump over 20 minutes, and thereafter, the monomer emulsified liquid A is further added dropwise thereinto through a metering pump over 200 minutes. Thereafter, the polymerization flask is maintained at 75° C. for 3 hours while stirring is continued slowly to complete the polymerization, and therefore an anionic thermosetting acrylic resin particle dispersion liquid (A2) in which a solid content is 30% by adjusting with ion exchange water.

The thermosetting acrylic resin particles contained in the anionic thermosetting acrylic resin particle dispersion liquid (A2) have a volume average particle diameter of 200 nm, a glass transition temperature of 65° C., and a weight-average molecular weight of 30,000.

Aggregation Step
Thermosetting acrylic resin particle dispersion liquid (A1): 220 parts by mass (solid content: 66 parts by mass)
Ion exchange water: 100 parts by mass

The above components are thoroughly mixed and dispersed in a round stainless steel flask with a homogenizer (ULTRA-TURRAX T50, manufactured by IKA Works GmbH &Co.). Next, a pH is adjusted to 2.8 by using an aqueous solution of 1.0% nitric acid. 0.60 parts of an aqueous solution of 10% polyaluminum chloride are added thereto, and a dispersing operation is continuously performed by using ULTRA-TURRAX.

A stirrer and a mantle heater are installed, a temperature is raised up to 52° C. while appropriately adjusting a rotation speed of the stirrer such that slurry is sufficiently stirred, the slurry is maintained at 52° C. for 15 minutes, and then when a volume average particle diameter becomes 5.7 μm, 70 parts by mass of the resin particle dispersion liquid is slowly charged.

Coalescence Union Step

After maintaining for 30 minutes after the addition, a pH is adjusted to 7.7 by using an aqueous solution of 5% of sodium hydroxide. Thereafter, a temperature is raised up to 90° C. and maintained for 2 hours. A nearly spherical shape is observed with an optical microscope.

Filtering Step, Washing Step, and Drying Step

After the reaction ends, a solution in the flask is cooled and is filtered, and therefore a solid content is obtained. Next, this solid content is sufficiently washed with ion exchange water, and then, solid liquid separation is performed by Nutsche type suction filtration, and therefore a solid content is obtained again.

Next, this solid content is dispersed again in 3,000 parts by mass of ion exchange water at 40° C., and stirred at 300 rpm for 15 minutes, and washed. The washing operation is repeated 5 times, the solid content obtained by performing the solid liquid separation by the Nutsche type suction filtration is subjected to vacuum drying for 12 hours.

The powder particles of this clear powder coating material have a volume average particle diameter D₅₀ᵥ of 10.5 μm and a degree of sphericity of 0.97.

External Addition of External Additives

0.5 parts by mass of hydrophobic silica (a primary particle diameter of 12 nm) are mixed with 100 parts by mass of these powder particles, and therefore a clear powder coating material 2H made of polyester resin is obtained.

### Examples 1 to 9 and Comparative Examples 1 to 3

Preparation of Coated Product

As a substrate, a zinc phosphate-treated cold-rolled steel plate (thickness: 0.6 mm, length: 150 mm, width: 70 mm, surface roughness Ra: 0.25 μm) is used.

Coating is performed by Corona Gun XR4-110C manufactured by ASAHI SUNAC CORPORATION under conditions in which voltage: 100 kV, current: 30 μA, air volume: 100 L/min, discharge amount: 130 g/min to 150 g/min, distance between the gun and the substrate: 250 mm, and earth ring distance: 80 mm. After coating the first layer with the powder coating material described in Table 2, a coating material is changed, the second layer is coated with the powder coating materials 2A to 2H described in Table 2 under the same conditions, and the coated layer is put into a chamber and baked at 170° C. for 20 minutes. Thereby, coated products of Examples 1 to 9 and Comparative Examples 1 to 3 are obtained, respectively.

The following evaluation is performed by using the obtained coated product.

Evaluation on Adhesiveness between First Layer and Second Layer

The obtained coating film is subjected to a cross cut test according to JIS K5600-5-6 to evaluate adhesiveness. Evaluation standards are shown below. As the numbers in the following classification become smaller, the adhesiveness becomes excellent.

Classification 0: There is no detachment of any lattice.

Classification 1: Small peeling of the surface coated film at the intersection of the cuts. The area of the peeling portion clearly does not exceed 5%.

Classification 2: The surface coated film is peeled off at the intersection along the line of the cut. The area of the peeling portion is 5% or more and less than 15%.

Classification 3: The surface coated film is partially and completely peeled off along the cut line. The area of the peeling portion is 15% or more and less than 35%.

Classification 4: The surface coated film is partially and completely exfoliated along the cut line. The area of the peeling portion is 35% or more and less than 65%.

Classification 5: The area of the peeling portion is 65% or more.

Evaluation on Color Unevenness Suppression in Appearance

The coated film layer portion formed of the obtained coated product is visually observed, and those having no color unevenness or having color unevenness but not the extent that is recognizable are evaluated as A, and those in which color unevenness are observed are evaluated as B.

Details of each of the examples and the evaluation results are collectively shown in Table 2.

TABLE 2

| | First layer | | | | | Second layer | | | | |
|---|---|---|---|---|---|---|---|---|---|---|
| | | | Volume | | | | | Volume | | |
| | | | average | | Avera- | | | average | | Avera- |
| | | | particle | | ge | | | particle | | ge |
| | | | diameter D1 | Sphericity | layer | | | diameter D2 | Sphericity | layer |
| | Type of | | of powder | S1 of | thick- | Type of | | of powder | S2 of | thick- |
| | powder | | coating | powder | ness | powder | | coating | powder | ness |
| | coating | | material | coating | T1 | coating | | material | coating | T2 |
| | material | Color | (μm) | material | (μm) | material | Color | (μm) | material | (μm) |
| Example 1 | 1A | Black | 44 | 0.94 | 76 | 2D | Red | 8.5 | 0.99 | 25 |
| Example 2 | 1A | Black | 44 | 0.94 | 65 | 2E | Clear | 10.2 | 0.98 | 22 |
| Example 3 | 1A | Black | 44 | 0.94 | 65 | 2F | Clear | 14.2 | 0.97 | 30 |
| Example 4 | 1A | Black | 44 | 0.94 | 68 | 2H | Clear | 10.5 | 0.97 | 27 |
| Example 5 | 1C | White | 30 | 0.92 | 80 | 2A | Red | 8.5 | 0.99 | 10 |
| Example 6 | 1C | White | 30 | 0.92 | 75 | 2B | Red | 11.1 | 0.97 | 22 |
| Example 7 | 1C | White | 30 | 0.92 | 70 | 2C | Red | 14.7 | 0.97 | 38 |
| Example 8 | 1C | White | 30 | 0.92 | 55 | 2C | Red | 14.7 | 0.97 | 38 |
| Example 9 | 1A | Black | 44 | 0.94 | 73 | 2E | Clear | 10.2 | 0.98 | 35 |
| Comparative | 1B | Black | 23 | 0.94 | 63 | 2G | Clear | 15.8 | 0.97 | 30 |
| example 1 | | | | | | | | | | |
| Comparative | 1A | Black | 44 | 0.94 | 75 | 2D | Clear | 6.2 | 0.99 | 10 |
| example 2 | | | | | | | | | | |
| Comparative | 1A | Black | 44 | 0.94 | 80 | 1C | Red | 30 | 0.92 | 60 |
| example 3 | | | | | | | | | | |
| | Center | | | | Degree of | | | | | |

| | line | | | | interface | | Evaluation result | |
|---|---|---|---|---|---|---|---|---|
| | average | | | | roughness Ra | Surface | | Inhibiting |
| | roughness | | | | between | coverage | Adhesiveness | properties |
| | Ra of | | | | first layer | of coated | between | of color |
| | outermost | | | | and second | film layer | first | unevenness |
| | layer | | | | layer | (% by | layer and | in |
| | (μm) | T1/T2 | S1/S2 | D1/D2 | (μm) | area) | second layer | appearance |
| Example 1 | 0.08 | 3.0 | 0.95 | 5.2 | 5.0 | 96 | 1 | A |
| Example 2 | 0.15 | 3.0 | 0.96 | 4.3 | 3.0 | 96 | 1 | A |
| Example 3 | 0.19 | 2.2 | 0.97 | 3.1 | 1.5 | 97 | 1 | A |
| Example 4 | 0.15 | 2.5 | 0.97 | 4.2 | 2.7 | 97 | 1 | A |
| Example 5 | 0.08 | 8.0 | 0.93 | 3.5 | 7.5 | 96 | 2 | B |
| Example 6 | 0.09 | 3.4 | 0.95 | 2.7 | 3.2 | 96 | 1 | A |
| Example 7 | 0.10 | 1.8 | 0.95 | 2.0 | 1.2 | 97 | 1 | A |
| Example 8 | 0.10 | 1.4 | 0.95 | 2.0 | 1.1 | 97 | 2 | A |
| Example 9 | 0.11 | 2.1 | 0.96 | 4.3 | 5.3 | 96 | 2 | A |
| Comparative | 0.08 | 2.1 | 0.97 | 1.5 | 0.8 | 97 | 4 | A |
| example 1 | | | | | | | | |
| Comparative | 0.13 | 7.5 | 0.95 | 7.1 | 12.0 | 98 | 4 | A |
| example 2 | | | | | | | | |
| Comparative | 0.18 | 1.3 | 1.02 | 1.5 | 0.9 | 95 | 3 | B |
| example 3 | | | | | | | | |

Based on the results shown in Table 2, the coated product of the present example is excellent as compared with the coated product of the comparative example in the adhesiveness between a first layer and a second layer in contact with the first layer in a case where the coated product has the first layer and the second layer as coated layers.

Based on the results shown in Table 2, the coated product of the present example is also excellent in suppressing color unevenness in the appearance.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A coated product comprising:
two or more coated layers,
wherein a degree of interface roughness Ra between a first layer in the coated film layer and a second layer in contact with the first layer is 1 μm to 10 μm.

2. The coated product according to claim 1,
wherein the second layer is an outermost layer of the coated product.

3. The coated product according to claim 1,
wherein an average layer thickness of the second layer is less than 40 μm.

4. The coated product according to claim 1,
wherein an average layer thickness of the first layer is 40 μm to 100 μm.

5. The coated product according to claim 1,
wherein a ratio (T1/T2) of an average layer thickness T1 of the first layer to an average layer thickness T2 of the second layer is more than 1 and 7 or less.

6. The coated product according to claim 5,
wherein a ratio (T1/T2) of an average layer thickness T1 of the first layer to an average layer thickness T2 of the second layer is 1.5 to 5.

7. The coated product according to claim 1,
wherein a surface coverage of the coated film layer is 95% by area or more.

8. The coated product according to claim 1,
wherein the second layer is a clear coated film layer.

9. The coated product according to claim 1, further comprising:
a substrate,
wherein a surface roughness Ra of the substrate is smaller than the degree of interface roughness Ra between the first layer and the second layer.

10. The coated product according to claim 1,
wherein a surface roughness Ra of an outermost surface of on a coated film layer side of the coated product is smaller than the degree of interface roughness Ra between the first layer and the second layer.

11. A powder coating material set comprising:
a first powder coating material that contains a resin and a curing agent; and
a second powder coating material that contains a resin and a curing agent,
wherein a ratio (D1/D2) of a volume average particle diameter D1 of the first powder coating material to a volume average particle diameter D2 of the second powder coating material is 1.6 to 7.

12. The powder coating material set according to claim 11,
wherein the volume average particle diameter of the second powder coating material is 5 μm to 15 μm.

13. The powder coating material set according to claim 11,
wherein a degree of sphericity of the second powder coating material is 0.97 or more.

14. The powder coating material set according to claim 11,
wherein a degree of sphericity of the second powder coating material is a value larger than a degree of sphericity of the first powder coating material.

15. The powder coating material set according to claim 11,
wherein a ratio (S1/S2) of a degree of sphericity S1 of the first powder coating material to a degree of sphericity S2 of the second powder coating material is 0.93 to 0.97.

16. A method for manufacturing a coated product, comprising:
applying a first powder coating material on a substrate;
applying a second powder coating material on the first powder coating material applied; and
heating and curing the first powder coating material and the second powder coating material applied,
wherein the first powder coating material and the second powder coating material in the powder coating material set according to claim 11 are used as the first powder coating material and the second powder coating material, respectively.
